(19) United States
(12) Patent Application Publication
(10) Pub. No.: US 2026/0050311 A1
(43) Pub. Date: Feb. 19, 2026

(54) PROCESSOR AND METHOD FOR CONTROLLING OPERATION OF PROCESSOR

(71) Applicant: Fujitsu Limited, Kawasaki-shi (JP)

(72) Inventor: Shinichiro SHIROTA, Kawasaki (JP)

(73) Assignee: Fujitsu Limited, Kawasaki-shi (JP)

(21) Appl. No.: 19/286,836

(22) Filed: Jul. 31, 2025

(30) Foreign Application Priority Data
Aug. 19, 2024 (JP) 2024-137515

(51) Int. Cl. G06F 1/26

(52) U.S. Cl. CPC G06F 1/263

(57) ABSTRACT

A processor includes an internal circuit; power supply switch circuits arranged in the internal circuit, each of the power supply switch circuits being configured to supply a power supply voltage to the internal circuit; a first control circuit configured to control the power supply switch circuits based on a result of comparison between a power supply voltage and a target voltage at a detection position provided in the internal circuit, and cause the power supply voltage in the internal circuit to be closer to the target voltage; and a second control circuit configured to increase a power supply capacity of the power supply switch circuit arranged near a shortage area, compared to a power supply capacity of the power supply switch circuit arranged at a position away from the shortage area, when there is the shortage area having a shortage in a power supply capacity in the internal circuit.

### CROSS-REFERENCE TO RELATED APPLICATION

This patent application is based upon and claims the benefit of priority of the prior Japanese Patent Application No. 2024-137515 filed on Aug. 19, 2024, the entire contents of which are incorporated herein by reference.

### FIELD

The present invention relates to a processor and a method for controlling the operation of the processor.

### BACKGROUND

There is known a method for independently adjusting power supply voltages supplied to a plurality of cores included in a processor by a power supply switch circuit provided for each core. This type of power supply switch circuit has a plurality of pMOS (p-channel metal oxide semiconductor) transistors arranged between an external power supply line and a power supply line of each core. The power supply control circuit controlling the power supply switch circuit compares the power supply voltage measured in the core with a target voltage, and generates a bit value to be output to the gate of each pMOS transistor as a digital control signal. Then, by applying the bit value of the digital control signal to the gate of each pMOS transistor of the power supply switch circuit, for example, the power supply voltage measured at one position in the core is brought closer to the target voltage (see, for example, Patent Document 1).
Patent Document 1: Japanese National Publication of International Patent Application No. 2018-019152

### SUMMARY

According to one aspect, a processor includes an internal circuit; a plurality of power supply switch circuits arranged by being distributed in the internal circuit, each of the plurality of power supply switch circuits being configured to supply a power supply voltage to the internal circuit; a first control circuit configured to control the plurality of power supply switch circuits based on a result of comparison between a power supply voltage and a target voltage at a detection position provided in the internal circuit, and cause the power supply voltage in the internal circuit to be closer to the target voltage; and a second control circuit configured to increase a power supply capacity of the power supply switch circuit arranged near a shortage area, compared to a power supply capacity of the power supply switch circuit arranged at a position away from the shortage area, when there is the shortage area having a shortage in a power supply capacity in the internal circuit.

The object and advantages of the invention will be implemented and attained by means of the elements and combinations particularly pointed out in the appended claims.

It is to be understood that both the foregoing general description and the following detailed description are exemplary and explanatory and are not restrictive of the invention as claimed.

### BRIEF DESCRIPTION OF THE DRAWINGS

FIG. 1 is a block diagram illustrating an example of a processor in one embodiment;

FIG. 2 is a block diagram illustrating an example of a processor in another embodiment;

FIG. 3 is an explanatory diagram illustrating an example of a gradient in the power supply voltage occurring in the core circuit of FIG. 2;

FIG. 4 is a block diagram illustrating an example of a setting register in FIG. 2;

FIG. 5 is a circuit diagram illustrating an example of a power supply control circuit and a power supply switch circuit included in the LDO of FIG. 2;

FIG. 6 is a circuit diagram illustrating an example of the power supply switch circuit of FIG. 5;

FIG. 7 is an explanatory diagram illustrating another example of a gradient occurring in the power supply voltage in the core circuit of FIG. 2;

FIG. 8 is a block diagram illustrating an example of a processor in another embodiment;

FIG. 9 is an explanatory diagram illustrating an example of a gradient occurring in the power supply voltage in the core circuit of FIG. 8;

FIG. 10 is a block diagram illustrating an example of another processor;

FIG. 11 is a circuit diagram illustrating an example of a power supply control circuit and a power supply switch circuit included in the LDO of FIG. 10;

FIG. 12 is a circuit diagram illustrating an example of the power supply switch circuit of FIG. 11;

FIG. 13 is a block diagram illustrating an example of a processor according to another embodiment; and

FIG. 14 is a block diagram illustrating an example of a processor according to another embodiment.

### DESCRIPTION OF EMBODIMENTS

For example, by arranging a plurality of power supply switch circuits in the core, occurrence of a gradient in the power supply voltage in the core is prevented. On the other hand, in the layout design of a processor, the power supply switch circuits may be arranged in an empty area after circuits such as computing units are laid out. Therefore, in some cases, a plurality of power supply switch circuits arranged in the core are not evenly distributed. In this case, the power supply voltage in the area away from the power supply switch circuits in the core is lower than the target voltage, and a gradient in the power supply voltage occurs in the core.

Further, a core may be mounted with a plurality of circuits having different current consumptions. In this case, even when the plurality of power supply switch circuits are evenly arranged in the core, the power supply voltage in the area where the circuit having a large current consumption is mounted becomes lower than the target voltage, and a gradient of the power supply voltage occurs in the core.

Embodiments will now be described with reference to the drawings. Hereinafter, a signal line through which a signal is transmitted is denoted by the same reference numeral as the signal name, and a voltage line through which a voltage is supplied is denoted by the same reference numeral as the voltage name.

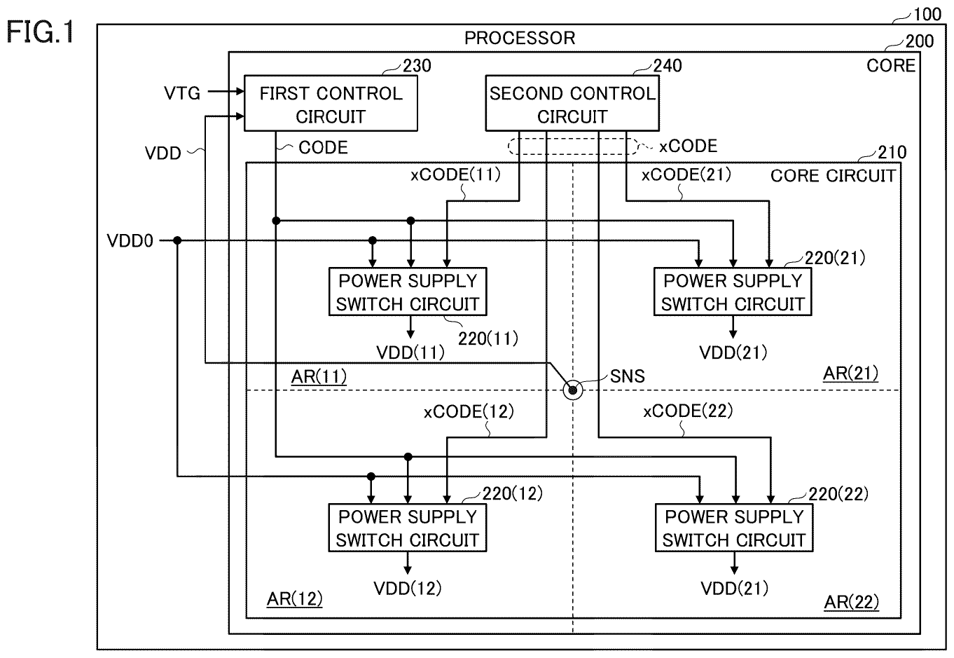

FIG. 1 illustrates an example of a processor in one embodiment. The processor 100 illustrated in FIG. 1 has a core 200 and peripheral circuits (not illustrated). For example, the peripheral circuits include an I/O circuit that inputs and outputs signals to and from the outside of the processor 100 and an operation control circuit that controls the operation of the core 200. The operation of the processor 100 described below may be implemented by the operation control method of the processor 100.

The core 200 includes a core circuit 210, a plurality of power supply switch circuits 220 arranged by being distributed within the core circuit 210, and a first control circuit 230 and a second control circuit 240 that control the plurality of power supply switch circuits 220. The core circuit 210 is an example of an internal circuit and may include various computing units such as floating-point computing units, and various circuits such as caches, schedulers, and register files.

The plurality of power supply switch circuits 220 reduce the power supply voltage VDD0 supplied from the outside of the core circuit 210 to generate the power supply voltage VDD used for the operation of the circuits in the core circuit 210. For example, the plurality of power supply switch circuits 220, the first control circuit 230, and the second control circuit 240 function as regulators for generating the power supply voltage VDD used in the core circuit 210 by using the power supply voltage VDD0 supplied from the outside of the core circuit 210.

The power supply voltage VDD0 is an example of an external power supply voltage, and the power supply line VDD0 supplied with the power supply voltage VDD0 is an example of an external power supply line. The power supply voltage VDD0 may be generated in the processor 100 or supplied from the outside of the processor 100. The power supply line VDD supplied with the power supply voltage VDD is an example of an internal power supply line. In FIG. 1, the areas AR(11), AR(12), AR(21), and AR(22) in which the power supply switch circuits 220 are arranged are illustrated by being divided into sections by broken lines.

Hereinafter, when the areas AR(11), AR(12), AR(21), and AR(22) are described without distinction, they are also referred to as areas AR or AR(xy). The area AR is an example of a circuit area in which a circuit is arranged. In FIG. 1, the power supply switch circuits 220 arranged in the respective areas AR(xy), the power supply voltage VDD generated by the power supply switch circuit 220, and the code xCODE supplied to the power supply switch circuit 220 are denoted at the end by the same symbol (xy) as the corresponding area AR. In FIG. 1, an example of the core circuit 210 having four areas AR is illustrated for simplicity of explanation, but the number of areas AR and power supply switch circuits 220 is not limited to four as long as there are a plurality.

The sections divided by broken lines do not indicate power supply separation. The power supply voltages VDD generated by the plurality of power supply switch circuits 220 are commonly used by the circuits in the core circuit 210. However, due to the current consumption of the circuits mounted in the respective areas AR in the core circuit 210, a gradient may occur in the power supply voltage VDD in the core circuit 210. Therefore, in the present embodiment, the occurrence of a gradient in the power supply voltage VDD in the core circuit 210 is prevented by adjusting the power supply capability of each power supply switch circuit 220 according to the code xCODE output from the second control circuit 240.

Each power supply switch circuit 220 has a plurality of power supply switches (not illustrated) which couple the power supply line VDD0 to the power supply line VDD in the core circuit 210 when turned on and cut off the coupling between the power supply line VDD0 and the power supply line VDD in the core circuit 210 when turned off. Each power supply switch circuit 220 adjusts the power supply capability of the power supply voltage VDD to the core circuit 210 by changing the number of power supply switches to be turned on according to the value of the common code indicated by the control signal received from the first control circuit 230.

Each power supply switch circuit 220 individually adjusts the supply capacity of the power supply voltage VDD to the core circuit 210 by adjusting the number of power supply switches to be turned on according to the value of the individual code xCODE indicated by the control signal received from the second control circuit 240. The control signal indicating the value of the common code CODE is an example of the first control signal, and the control signal indicating the value of the individual code xCODE is an example of the second control signal.

For example, the first control circuit 230 has a voltage comparator (not illustrated) for comparing the power supply voltage VDD and the target voltage VTG at a predetermined detection position SNS in the core circuit 210. The first control circuit 230 generates a common code CODE of a plurality of bits based on the comparison result between the power supply voltage VDD and the target voltage VTG, and outputs the generated code CODE to the plurality of power supply switch circuits 220.

When the power supply voltage VDD at the detection position SNS is lower than the target voltage VTG, the first control circuit 230 generates a code CODE for increasing the number of the power supply switches to be turned on in each power supply switch circuit 220. When the power supply voltage VDD at the detection position SNS is higher than the target voltage VTG, the first control circuit 230 generates a code CODE for decreasing the number of the power supply switches to be turned on in each power supply switch circuit 220. Then, the first control circuit 230 controls the plurality of power supply switch circuits 220 based on the generated code CODE, and makes the power supply voltage VDD in the core circuit 210 approach the target voltage VTG.

The power supply voltage VDD at the detection position SNS may be detected by a voltage detection circuit provided at the detection position SNS. In this case, a signal indicating the value of the power supply voltage VDD is transmitted from the detection position SNS to the first control circuit 230. The power supply voltage VDD at the detection position SNS may be detected by a voltage detection circuit provided in the first control circuit 230. In this case, a power supply line VDD is wired from the detection position SNS to the first control circuit 230. Further, the power supply voltage VDD at the detection position SNS may be detected by a voltage detection circuit provided between the detection position SNS and the first control circuit 230.

The second control circuit 240 generates codes xCODE to be output to the power supply switch circuits 220 arranged in each area AR. For example, the second control circuit 240 has a setting register (not illustrated) that externally holds, in a rewritable manner, the value of each code xCODE, and outputs the value set in the setting register as the code xCODE. The setting register may be provided by using an electrically rewritable nonvolatile memory storage area.

For example, if there is a shortage area in the core circuit 210 where the power supply capacity by the power supply switch circuit 220 is insufficient, the power supply voltage VDD in the shortage area may be lower than the target voltage VTG even when the power supply capacity is controlled by the first control circuit 230. Therefore, the code xCODE supplied to the power supply switch circuit 220 arranged in the area AR including the shortage area is set to a value that can individually increase the power supply capacity.

The power supply switch circuit 220 receiving the code xCODE indicating a value for increasing the power supply capacity increases the power supply capacity by further increasing the number of power supply switches that are turned on by the code CODE. That is, the second control circuit 240 increases the power supply capacity of the power supply switch circuit 220 arranged near the shortage area, to be higher than the power supply capacity of the power supply switch circuit 220 arranged at a position away from the shortage area. Thus, the value of the power supply voltage VDD in the core circuit 210 can be made uniform, and the occurrence of a gradient in the power supply voltage VDD can be prevented. As a result, the lowering of the operating voltage margin of the processor 100 can be prevented.

For example, due to the layout of the circuits installed in the core circuit 210, there are cases in which the power supply switch circuits 220 are not evenly distributed in the core circuit 210. In this case, one or more of the areas AR may include circuits whose power supply capability is insufficient due to the distance from the power supply switch circuit 220.

Further, the area AR in which a circuit whose current consumption is larger than that of circuits in other areas AR is arranged, may be a shortage area in which the power supply capacity is insufficient. Whether the current consumption of a circuit arranged in the area AR is large or not can be determined at the time of designing the processor 100 (circuit design, layout design, etc.).

For example, if the shortage area in which the power supply capacity is insufficient is known at the time of designing the processor 100, the code xCODE may be set in the setting register in the second control circuit 240 at the time of starting the processor 100. If the setting register is provided by using a nonvolatile memory and the code xCODE can be set in advance in the setting register, the setting processing of the setting register at the time of starting the processor 100 need not be performed.

Further, for example, if one of the areas AR includes a computing unit such as a floating-point computing unit whose current consumption during operation is larger than that of other computing units, the second control circuit 240 may include an operation monitoring circuit for monitoring the operation of the computing unit such as a floating-point computing unit.

When a computing unit having a large current consumption during operation operates, the operation monitoring circuit in the second control circuit 240 sets the code xCODE supplied to the power supply switch circuit 220 included in the area AR in which the computing unit having a large current consumption during operation is arranged, to a value that increases the power supply capacity. For example, the operation monitoring circuit may detect the execution of an operation instruction with a large current consumption based on the decoding result of the instruction decoder mounted in the core circuit 210. Alternatively, if the core circuit 210 has a scheduler that temporarily holds the decoded instruction information until the information is issued to the computing unit, the operation monitoring circuit may detect the execution of an operation instruction with a large current consumption based on the instruction issued from the scheduler to the computing unit.

The embodiment illustrated in FIG. 1 has the first control circuit 230 that commonly controls the power supply capacity of a plurality of power supply switch circuits 220 arranged by being distributed in the core circuit 210, and the second control circuit 240 that individually controls the power supply capacity of a plurality of power supply switch circuits 220. Thus, under the control of the first control circuit 230, the power supply voltage VDD in the core circuit 210 can be brought closer to the target voltage VTG. Further, under the control of the second control circuit 240, the power supply capacity of the power supply switch circuit 220 near the shortage area in the core circuit 210 where the power supply capacity is insufficient, can be increased.

Thus, the value of the power supply voltage VDD in the core circuit 210 can be made uniform regardless of the position of the power supply switch circuit 220, the difference in the current consumption of the circuits in the core circuit 210, or the difference in the current consumption due to the operation/non-operation of the circuits in the core circuit 210. As a result, the occurrence of a gradient in the power supply voltage VDD can be prevented, and the lowering of the operating voltage margin of the processor 100 can be prevented.

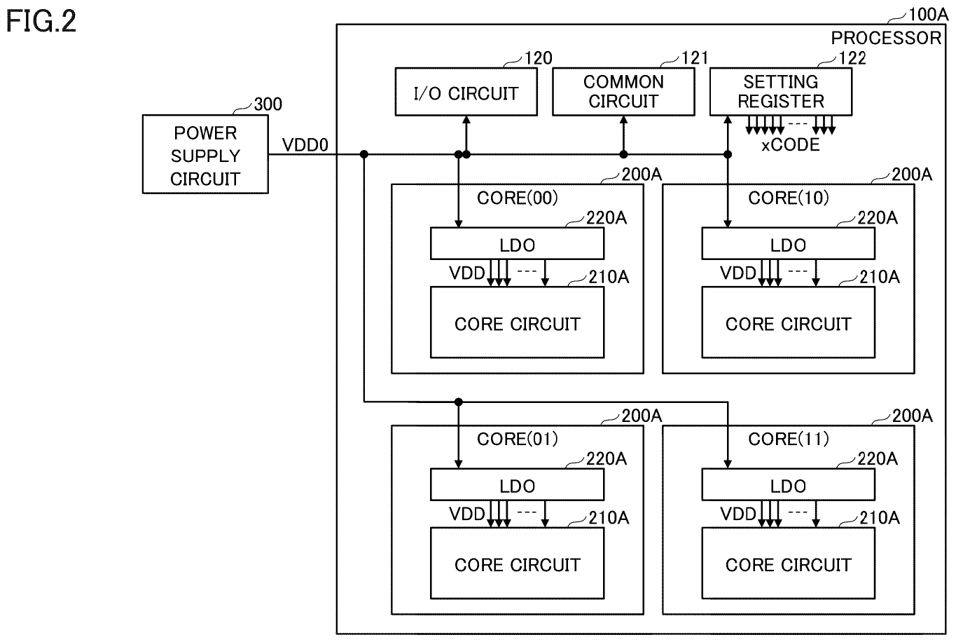

FIG. 2 illustrates an example of a processor according to another embodiment. Elements similar to those in FIG. 1 are denoted by the same reference numerals, and detailed descriptions thereof are omitted. A processor 100A illustrated in FIG. 2 includes a plurality of cores 200A, an I/O (input/output) circuit 120, a common circuit 121, and a setting register 122. In the example illustrated in FIG. 2, the processor 100A has four cores 200A indicated by identification codes (00), (10), (01), and (11), but the number of the cores 200A may be 1 or more. The processor 100A operates by receiving a power supply line VDD0 generated by a power supply circuit 300 such as a POL (point of load) power supply provided outside the processor 100A. The operation of the processor 100A described below may be implemented by an operation control method of the processor 100A.

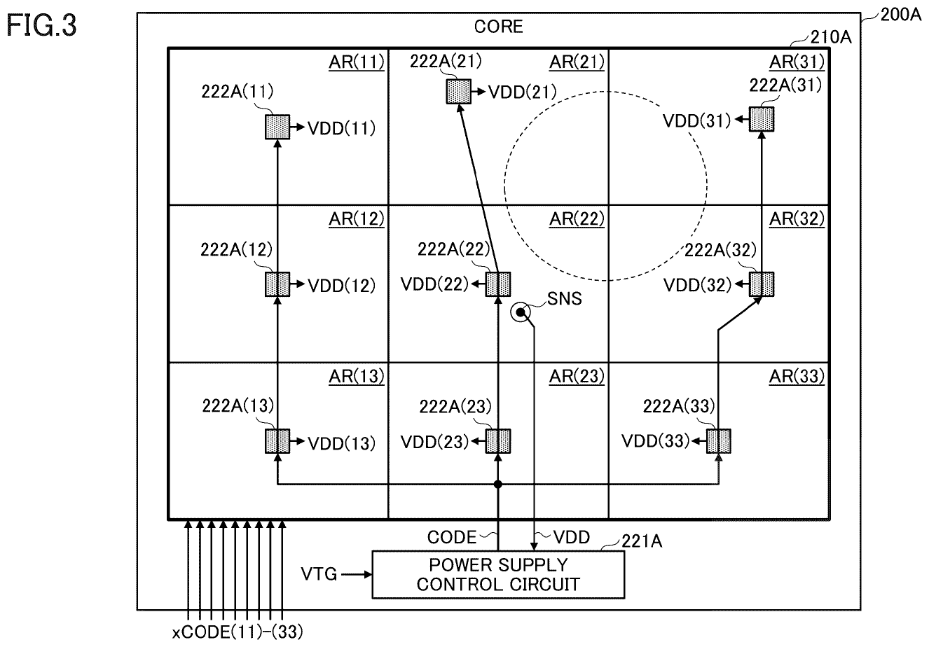

Each core 200A has a core circuit 210A and a low drop out (LDO) 220A. The LDO 220A generates a plurality of power supply voltages VDD by means of a plurality of power supply switch circuits 222A (FIG. 3) that lower the power supply voltage VDD0 supplied from the power supply circuit 300 and supply the power supply voltage VDD0 to a plurality of circuit areas of the core circuit 210.

FIG. 2 illustrates an example in which each LDO 220A is arranged outside the core circuit 210A for the sake of clarity, but actually, a part of the circuits of the LDO 220A are arranged inside the core circuit 210A. The core circuit 210A may include various computing units such as a floating-point computing unit, and various circuits such as a cache, a scheduler, and a register file. The core circuit 210A is an example of an internal circuit.

The I/O circuit 120 has an input buffer that receives signals from the outside of the processor 100 and an output buffer that outputs signals to the outside of the processor 100. The common circuit 121 includes, for example, a control circuit commonly used by a plurality of cores 200A. The setting register 122 holds a value of a code xCODE that individually controls the LDO 220A of each core 200A, and outputs a plurality of control signals indicating the held value of the code xCODE to each LDO 220A.

The setting register 122 is an example of a holding unit that holds the increase amount in the power supply capacity of the power supply switch circuit 222A, which is arranged near a shortage area where the power supply capacity is insufficient in the core circuit 210A. The setting register 122 may be provided by using a storage area of an electrically rewritable non-volatile memory, or may be provided by using a ROM (Read Only Memory), a fuse, or a wiring pattern whose voltage value is fixed. Although FIG. 2 illustrates the setting register 122 corresponding to the core circuit 210A of one core 200A, the setting register 122 is provided for each core 200A.

In FIG. 2, a description of the clock for operating the processor 100A and the circuit for controlling the clock frequency is omitted. For example, the processor 100A has a function of dynamic voltage and frequency scaling (DVFS) control for dynamically controlling the power supply voltage VDD and the clock frequency for each core 200A according to the processing load allocated to each core 200A.

FIG. 3 illustrates an example in which the gradient of the power supply voltage VDD occurs in the core circuit 210A of FIG. 2. The core 200A illustrated in FIG. 3 is one of the four cores 200A illustrated in FIG. 2. The core 200A has a power supply control circuit 221A and a core circuit 210A including a plurality of power supply switch circuits 222A arranged in each area AR. The plurality of power supply switch circuits 222A are arranged in each area AR and are arranged between the power supply line VDD0 and the power supply line VDD. The power supply control circuit 221A and the power supply switch circuit 222A are included in the LDO 220A illustrated in FIG. 2.

In the example illustrated in FIG. 3, the core circuit 210 is divided into 9 areas AR(xy) of 3 rows and 3 columns. The symbol x indicates the column number of the area AR, and the symbol y indicates the row number of the area AR. For example, the detection position SNS for detecting the power supply voltage VDD in the core circuit 210A is provided in the area AR(22) located in the center of the core circuit 210A. In the present embodiment, it is assumed that the current consumption of the circuits arranged in each area AR is similar to each other.

The power supply control circuit 221A generates a multi-bit common code CODE based on the comparison result between the power supply voltage VDD and the target voltage VTG at the detection position SNS, and outputs the generated code CODE to the 9 power supply switch circuits 222A. The power supply switch circuit 222A reduces the power supply voltage VDD0 based on the multi-bit common code CODE and the multi-bit code xCODE for each area AR, to generate the power supply voltage VDD.

For example, in the layout design of the processor 100A, the circuit which implements the function of the processor 100 is laid out with high priority, and the power supply switch circuit 222A is laid out using an empty area where the circuit is not laid out. In the example illustrated in FIG. 3, one or more circuits are laid out in an area located across the areas AR(21), AR(31), AR(22), and AR(32). Further, the power supply switch circuits 222A in the areas AR(21), AR(31), and AR(32) are laid out at positions deviated from the center of each area AR. Therefore, the arrangement density of the power supply switch circuits 222A in the core circuit 210A varies.

The circle indicated by a dashed line illustrated in FIG. 3 indicates an area where the power supply voltage VDD tends to be lower than the target voltage VTG due to the long distance from the power supply switch circuit 222A. That is, the circle indicated by a dashed line illustrated in FIG. 3 indicates a shortage area where the power supply capacity is lower than that of other areas due to a decrease in the arrangement density of the power supply switch circuit 222A.

The position of each power supply switch circuit 222A in each area AR is known when the layout design of the processor 100 is completed. Further, for example, a code xCODE to be set in the setting register 122 of FIG. 2 is determined for each power supply switch circuit 222A according to the amount of deviation of each power supply switch circuit 222A from the center of each area AR.

In the example illustrated in FIG. 3, the power supply switch circuit 222A (21) of the area AR(21) has the largest amount of deviation from the center of the area AR(21). The power supply switch circuit 222A (31) of the area AR(31) has the second largest amount of deviation from the center of the area AR(31). The power supply switch circuit 222A (32) of the area AR(32) has the third largest amount of deviation from the center of the area AR(32). The power supply switch circuit 222A of each of the other areas AR is located at the center of the corresponding area AR.

Therefore, the code xCODE supplied to the power supply switch circuit 222A (21) is set to a value which makes the increase rate of the power supply capacity to the power supply capacity set by the code CODE, to be the largest. The code xCODE supplied to the power supply switch circuit 222A (31) is set to the value which makes the increase rate of the power supply capacity to the power supply capacity set by the code CODE, to be the second largest. The code xCODE supplied to the power supply switch circuit 222A (32) is set to the value which makes the increase rate of the power supply capacity to the power supply capacity set by the code CODE, to be the third largest. The code xCODE supplied to the other power supply switch circuits 222A is set to the value which maintains the power supply capacity set by the code CODE.

For example, the setting register 122 of FIG. 2 holds an increase amount in the power supply capacity corresponding to the amount of deviation, the deviation being from the position (i.e., center of each area RA) of the power supply switch circuit 222A when the plurality of power supply switch circuits 222A are evenly distributed in the core circuit 210A. The increase amount in the power supply capacity held in the setting register 122 is set to a value which increases the current supply capacity as the amount of deviation increases.

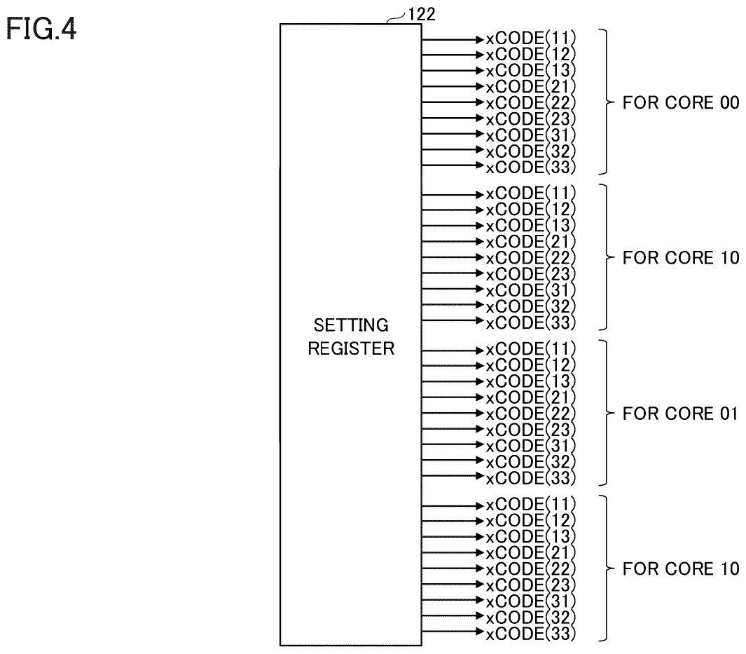

FIG. 4 illustrates an example of the setting register 122 of FIG. 2. The setting register 122 outputs 9 codes xCODE for each core 200A. As illustrated in FIG. 3, each core 200A includes 9 areas AR(xy), and the setting register 122 outputs 9 codes xCODE (xy) corresponding to the 9 areas AR of each core 200A.

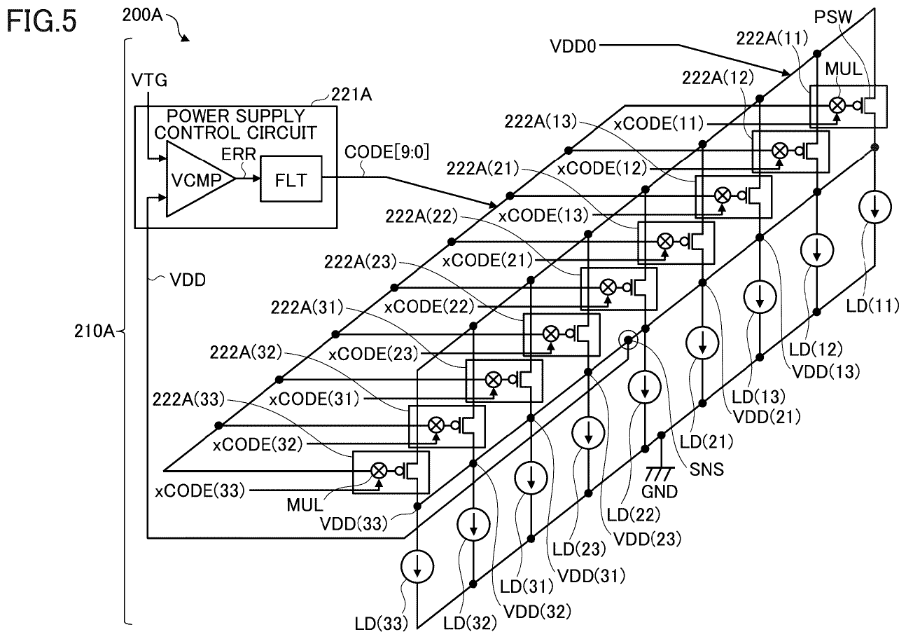

FIG. 5 illustrates an example of the power supply control circuit 221A and the power supply switch circuits 222A included in the LDO 220A of FIG. 2. The power supply control circuit 221A has a voltage comparator VCMP and a filter FLT. The power supply control circuit 221A is an example of the first control circuit.

The voltage comparator VCMP compares the power supply voltage VDD and the target voltage VTG at the detection position SNS in the core circuit 210A, and outputs an error value ERR corresponding to the difference between the power supply voltage VDD and the target voltage VTG. The error value ERR is an example of the comparison result between the power supply voltage VDD and the target voltage VTG.

The filter FLT filters the error value ERR to generate a 10 bit code CODE [9:0]. For example, the filter FLT performs feedback control by PID (Proportional Integral Differential). The binary number indicated by the code CODE [9:0] indicates the number of switches that are turned on among the power supply switches PSW provided in the power supply switch circuit 222A.

The power supply switch circuit 222A has a plurality of power supply switches PSW, each including a different number of pMOS transistors. The power supply switch circuit 222A increases the number of transistors that are turned on among the pMOS transistors, as the power supply voltage VDD becomes lower than the target voltage VTG, to increase the power supply capability. As a result, the voltage drop amount decreases and the power supply voltage VDD increases.

As the power supply voltage VDD becomes higher than the target voltage VTG, the power supply switch circuit 222A decreases the number of transistors to be turned on among the pMOS transistors, to decrease the power supply capability. By the above operation, the power supply voltage VDD is maintained at the target voltage VTG. That is, the power supply control circuit 221A controls the plurality of power supply switch circuits 222A based on the generated code CODE [9:0], and causes the power supply voltage VDD in the core circuit 210A to approach the target voltage VTG.

Further, in the present embodiment, the power supply switch circuit 222A (xy) arranged in each area AR(xy) in FIG. 3 has a multiplier MUL. The multiplier MUL and the setting register 122 illustrated in FIG. 2 are examples of the second control circuit.

The multiplier MUL multiplies the binary number indicated by the code CODE [9:0] output from the power supply control circuit 221A by the value indicated by the code xCODE, and outputs, to the power supply switch PSW, the value of each bit of the binary code CODE+[9:0] obtained by the multiplication.

Then, each power supply switch circuit 222A arranged in each area AR of FIG. 3 turns on a number of the pMOS transistors PT indicated by the binary code CODE+[9:0] output from the multiplier MUL. Thus, the power supply voltage VDD generated based on the code CODE [9:0] can be adjusted by the code xCODE for each area AR of FIG. 3. The multiplier MUL is an example of an adjustment circuit which adjusts the value indicated by the code CODE [9:0] according to the value indicated by the code xCODE to generate the code CODE+[9:0], and outputs each bit of the code CODE+[9:0] to the corresponding power supply switch PSW.

The power supply voltage VDD (xy) output from each power supply switch circuit 222A is supplied as the common power supply voltage VDD of the core circuit 210A, to a circuit which is a current load LD (xy) arranged between the power supply line VDD (xy) of each area AR and the ground line GND.

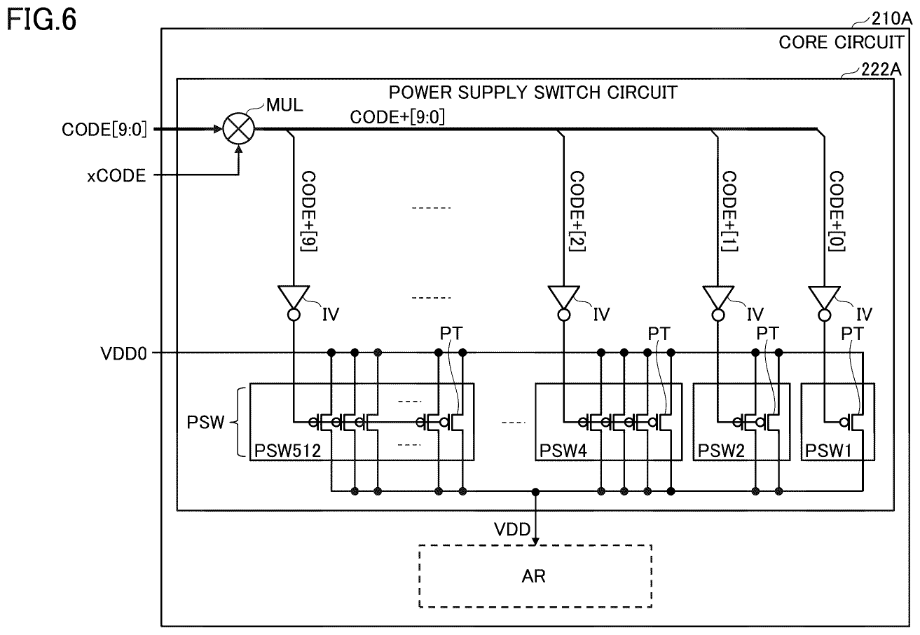

FIG. 6 illustrates an example of the power supply switch circuit 222A of FIG. 5. FIG. 6 illustrates an example of the power supply switch circuit 222A arranged in one of the 9 areas AR of FIG. 3. The power supply switch circuit 222A has 10 inverters IV in addition to the multiplier MUL and the power supply switch PSW illustrated in FIG. 5. The multiplier MUL multiplies the binary value indicated by the code CODE [9:0] and the value of the code xCODE, and outputs the result as a 10 bit code CODE+[9:0] to the power supply switch PSW.

For example, when the value of the code xCODE is 1.5 times, the multiplier MUL outputs the code CODE+[9:0] obtained by multiplying the value of the code CODE [9:0] by 1.5. When the value of the code xCODE is 1.8 times, the multiplier MUL outputs the code CODE+[9:0] obtained by multiplying the value of the code CODE [9:0] by 1.8. The code CODE+[9:0], which is the multiplication result of the multiplier MUL, is rounded to a value that can be expressed as a binary number.

The power supply switch circuit 222A has 10 power supply switches PSW, each including an n power of 2 (n being an integer of 0 to 9) of pMOS transistors PT. A number (512, 4, 2, 1) added after the code PSW of each power supply switch PSW indicates the number of pMOS transistors included in the power supply switch PSW. The 10 power supply switches PSW sequentially differ by 2 times in current supply capacity to the area AR.

The power supply switch circuit 222A having 10 power supply switches PSW has a total of 1023 pMOS transistors PT. A plurality of pMOS transistors PT in each power supply switch PSW (excluding PSW1) are coupled in parallel between power supply line VDD0 and power supply line VDD. The pMOS transistors PT of power supply switch PSW1 are coupled between power supply line VDD0 and power supply line VDD.

Each bit of the code CODE+[9:0] is coupled via inverter IV to the power supply switch PSW having the largest number of pMOS transistors PT in order from the upper bit. Then, all pMOS transistors PT included in each power supply switch PSW are turned on or off according to the bit value of the corresponding code CODE+.

For example, when the value of code CODE+[9] is “1”, all of the 512 pMOS transistors PT of power supply switch PSW512 are turned on. When the value of code CODE+[9] is “0”, all of the 512 pMOS transistors PT of power supply switch PSW512 are turned off. Similarly, when the value of code CODE+[2] is “1”, all of the 4 pMOS transistors PT of power supply switch PSW4 are turned on. When the value of code CODE+[2] is “0”, all of the 4 pMOS transistors PT of power supply switch PSW4 are turned off.

By turning the pMOS transistors PT on or off for each power supply switch PSW, the number of pMOS transistors PT indicated by the value of code CODE+[9:0] can be turned on. Thus, the power supply voltage VDD can be supplied to the area AR with the current supply capacity corresponding to the value of code CODE+[9:0].

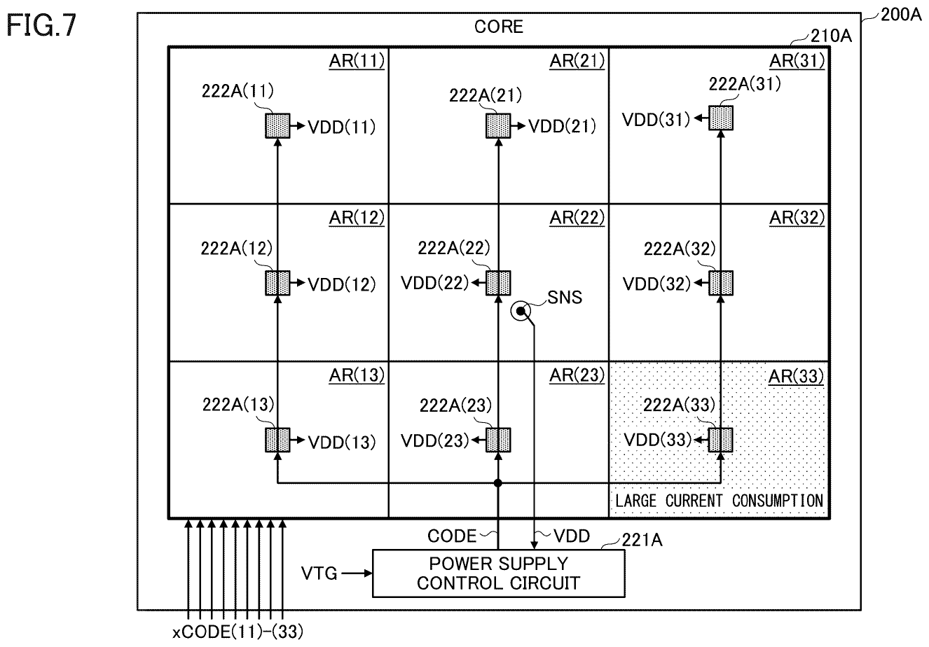

FIG. 7 illustrates another example in which the gradient of the power supply voltage VDD occurs in the core circuit 210A of FIG. 2. The same elements as those in FIG. 3 are denoted by the same reference numerals, and a detailed description thereof is omitted. In the example illustrated in FIG. 7, it is known in advance when the processor 100A is designed that the current consumption of the circuit mounted in the area AR(33) is larger than the current consumption of the circuits mounted in the other areas AR.

In this case, if the power supply voltage VDD is generated in all the power supply switch circuits 222A by using only the code CODE common to all the areas AR, the power supply voltage VDD of the area AR(33) becomes lower than the target voltage VTG. Therefore, a gradient of the power supply voltage VDD occurs in the core circuit 210A.

Therefore, the value of the code xCODE (33) corresponding to the area AR(33) including the circuit with the large current consumption is set to be larger than the value of the other codes xCODE, and the current supply capacity of the power supply voltage VDD in the area AR(33) is increased. By increasing the current supply capacity of the area AR(33) including the circuit with the large current consumption compared to the current supply capacity of the other areas AR, it is possible to prevent the occurrence of a gradient of the power supply voltage VDD in the core circuit 210A.

Thus, also in the embodiments illustrated in FIGS. 2 to 7, the same effect as in the embodiment illustrated in FIG. 1 can be obtained. For example, the power supply capacity of the power supply switch circuit 222A near the shortage area in the core circuit 210A where the power supply capacity is insufficient, can be increased by the setting register 122 and the multiplier MUL.

For example, it is possible to prevent the occurrence of a gradient of the power supply voltage VDD in the core circuit 510 even when the power supply switch circuit 222A is laid out at a position deviated from the center of each area AR. Moreover, it is possible to prevent the occurrence of a gradient of the power supply voltage VDD in the core circuit 510 even when there is an area AR whose current consumption is larger than that of other areas AR. As a result, lowering of the operating voltage margin of the processor 100 can be prevented.

In FIG. 3, a description is given of an example of increasing the power supply capability by increasing the value of the code xCODE supplied to the power supply switch circuit 222A arranged in the area AR where the arrangement density of the power supply switch circuits 222A is lower than other areas. However, the power supply capability may be reduced by decreasing the value of the code xCODE supplied to the power supply switch circuit 222A arranged in the area AR where the arrangement density of the power supply switch circuit 222A is higher than other areas.

In FIG. 7, a description is given of an example of increasing the power supply capability by increasing the value of the code xCODE supplied to the power supply switch circuit 222A arranged in the area AR where the current consumption is higher than other areas. However, the power supply capability may be reduced by decreasing the value of the code xCODE supplied to the power supply switch circuit 222A arranged in the area AR where the current consumption is lower than other areas.

By decreasing the value of the code xCODE, it is possible to prevent wasteful power consumption while preventing occurrence of a gradient of the power supply voltage VDD in the core circuit 510. However, in this case, the value of the code CODE [9:0] at a standard time of the current supply capacity of the power supply switch circuit 222A, is set to the median value (for example, 511), for example, and the magnification indicated by the value of the code xCODE can be set to be smaller than 1.

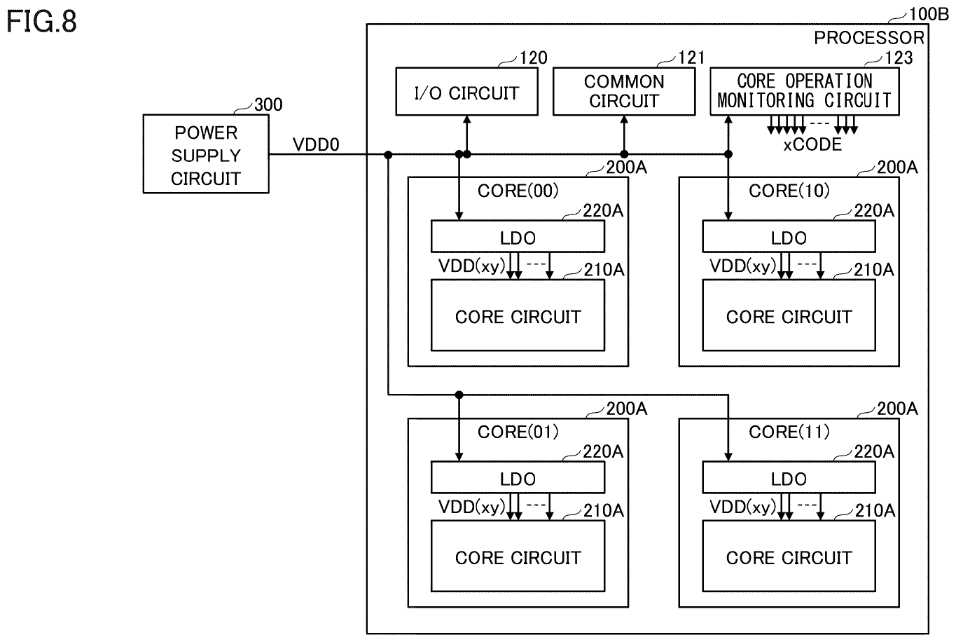

FIG. 8 illustrates an example of a processor according to another embodiment. The same elements as those in FIG. 2 are denoted by the same reference numerals, and a detailed description thereof is omitted. The processor 100B illustrated in FIG. 8 has the same circuit configuration as the processor 100A illustrated in FIG. 2, except that a core operation monitoring circuit 123 is provided instead of the setting register 122 illustrated in FIG. 2. FIG. 8 illustrates the core operation monitoring circuit 123 corresponding to the core circuit 210A of one core 200A. The core operation monitoring circuit 123 is provided for each core 200A. The operation of the processor 100B described below may be implemented by the operation control method of the processor 100B.

Among the circuits mounted in the core circuit 210A, the core operation monitoring circuit 123 monitors the operation of a specific circuit whose current consumption during operation is larger than that of the other circuits. The core operation monitoring circuit 123 is an example of an operation monitoring circuit for monitoring the operation of a circuit included in a circuit area which becomes a shortage area due to insufficient power supply capacity during operation, among a plurality of circuit areas in the core circuit 210A. The specific circuit whose operation is to be monitored by the core operation monitoring circuit 123 is an example of the first circuit, and when the specific circuit operates, a shortage area in which power supply capacity is insufficient is generated.

For example, the specific circuit is a floating-point computing unit. The core operation monitoring circuit 123 determines that the floating-point computing unit operates based on floating-point arithmetic instruction information from an instruction decoder or a scheduler (not illustrated). When the core operation monitoring circuit 123 determines that the floating-point computing unit operates, the core operation monitoring circuit 123 increases the value of the code xCODE corresponding to the area AR including the floating-point computing unit until the operation of the floating-point computing unit stops. Note that the specific circuit may be a circuit including many multiply-and-accumulate computing units such as an engine for deep learning inference processing. In this case, the multiply-and-accumulate computing unit may be a floating-point type or an integer type.

Note that the specific circuit having a large current consumption during operation may be a SIMD (Single Instruction Multiple Data) computing unit. In this case, when the SIMD arithmetic instruction is executed by the SIMD computing unit, the core operation monitoring circuit 123 increases the value of the code xCODE corresponding to the area AR including the SIMD computing unit. Note that when the SISD (Single Instruction Single Data) arithmetic instruction is executed by the SIMD computing unit, the core operation monitoring circuit 123 does not have to increase the value of the code xCODE corresponding to the area AR including the SIMD computing unit.

Also, the core operation monitoring circuit 123 does not increase the value of the code xCODE corresponding to the area AR not including the SIMD computing unit. In this way, when the core operation monitoring circuit 123 detects that the processing of a specific pattern in which the current consumption increases is to be executed, the core operation monitoring circuit 123 increases the value of the code xCODE corresponding to only the area AR executing the processing of the specific pattern during the execution of the processing of the specific pattern. Thus, it is possible to prevent the occurrence of a gradient of the power supply voltage VDD in the core circuit 210A even when one or more of the areas AR includes a specific circuit with a large current consumption during operation.

Note that the core operation monitoring circuit 123 may monitor the operation of the floating-point arithmetic circuit including a plurality of floating-point computing units or the SIMD arithmetic circuit including a plurality of SIMD computing units, and may increase the value of the code xCODE of the specific area AR based on the monitoring result.

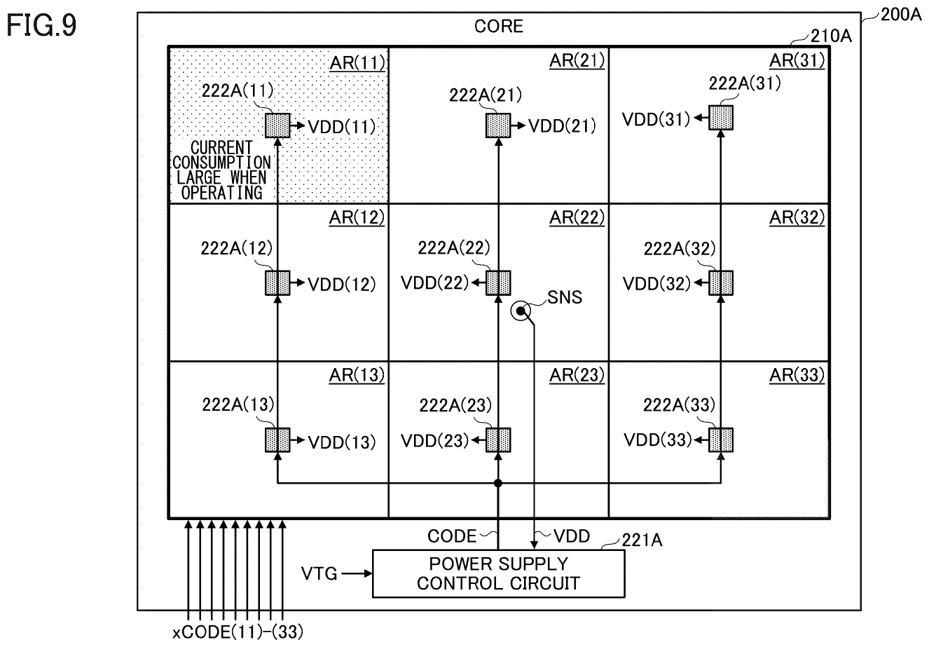

FIG. 9 illustrates an example of the occurrence of a gradient of the power supply voltage VDD in the core circuit 210A of FIG. 8. The same elements as those in FIG. 3 are denoted by the same reference numerals, and a detailed description thereof is omitted. In the example illustrated in FIG. 9, it is known in advance when the processor 100A is designed, that a circuit, whose current consumption during operation is larger than that of other circuits, is mounted in the area AR(11). For example, the current consumption during non-operation of a circuit whose current consumption during operation is larger than that of other circuits, may be lower than the current consumption during operation of other circuits, or may be equal to the current consumption during non-operation of other circuits.

The core operation monitoring circuit 123 illustrated in FIG. 8 monitors the operation of a specific circuit mounted in the area AR(11) and whose current consumption during operation is larger than that of other circuits. When the specific circuit operates, the core operation monitoring circuit 123 increases the value of the code xCODE corresponding to the power supply switch circuit 222A (11) included in the area AR(11) until the operation stops.

Assume that a specific circuit whose current consumption during operation is larger than that of other circuits, is mounted in the area AR(22) including the detection position SNS of the power supply voltage VDD. In this case, the power supply voltage VDD of the area AR(22) can be brought closer to the target voltage VTG only by the control of the code CODE [9:0]. However, when the circuit mounted in the area AR(22) operates, the power supply capacity of the other areas AR becomes excessive and wasteful power is consumed.

In such a case, the core operation monitoring circuit 123 may set the value of the code xCODE other than the code xCODE (22), to be smaller than the value of the code xCODE (22), when the circuit mounted in the area AR(22) operates. For example, the core operation monitoring circuit 123 may set the value of the code xCODE other than the code xCODE (22) to be smaller, as the value of the code CODE [9:0] increases due to the operation of the circuit mounted in the area AR(22). Thus, when the circuit mounted in the area AR(22) operates, the power supply capacity of the other areas AR can be prevented from becoming excessive, and an increase in the current consumption of the processor 100A can be prevented.

Further, there is a case where it takes time for the value of the code CODE [9:0] to increase after the circuit mounted in the area AR(22) starts operation. In this case, the core operation monitoring circuit 123 may temporarily increase the value of the code xCODE (22) until the value of the code CODE [9:0] increases. Then, after the value of the code CODE [9:0] increases, the value of the code xCODE (22) may be restored to the original value, and the value of the code xCODE other than the code xCODE (22) may be set to a small value. In this case, the value of the code CODE [9:0] of the standard time of the current supply capacity of the power supply switch circuit 222A is set to, for example, the median value (for example, 511), and the magnification indicated by the value of the code xCODE can be set to be less than 1.

Note that a specific circuit whose current consumption during operation is smaller than that during operation of other circuits, may be included in the area AR other than the area AR(22) including the detection position SNS. In this case, the core operation monitoring circuit 123 may output a code xCODE for reducing the current supply capacity of the power supply switch circuit 222A included in the area AR where the specific circuit is mounted, when the specific circuit is operated. As a result, the increase in the current consumption of the processor 100A can be prevented.

As described above, the same effect as the embodiment illustrated in FIG. 1 can be obtained in the embodiment illustrated in FIGS. 8 and 9. For example, the power supply capacity of the power supply switch circuit 222A near the shortage area in the core circuit 210A where the power supply capacity is insufficient, can be increased by the core operation monitoring circuit 123 and the multiplier MUL.

Further, in the embodiment illustrated in FIGS. 8 and 9, it is also possible to prevent the occurrence of a gradient of the power supply voltage VDD in the core circuit 510 even when the current consumption during operation of the circuit mounted in one area AR is larger than the current consumption during operation of the circuit mounted in another area AR.

In FIG. 9, a description is given of an example of increasing the power supply capacity by increasing the value of the code xCODE during operation of the circuit, supplied to the power supply switch circuit 222A arranged in the area AR where the current consumption during operation of the circuit is larger than the other areas AR. However, the power supply capacity may be decreased by decreasing the value of the code xCODE during operation of the circuit supplied to the power supply switch circuit 222A arranged in the area AR where the current consumption during operation of the circuit is smaller than the other areas AR. By reducing the value of the code xCODE, it is possible to prevent unnecessary power consumption while preventing the occurrence of a gradient of the power supply voltage VDD in the core circuit 510.

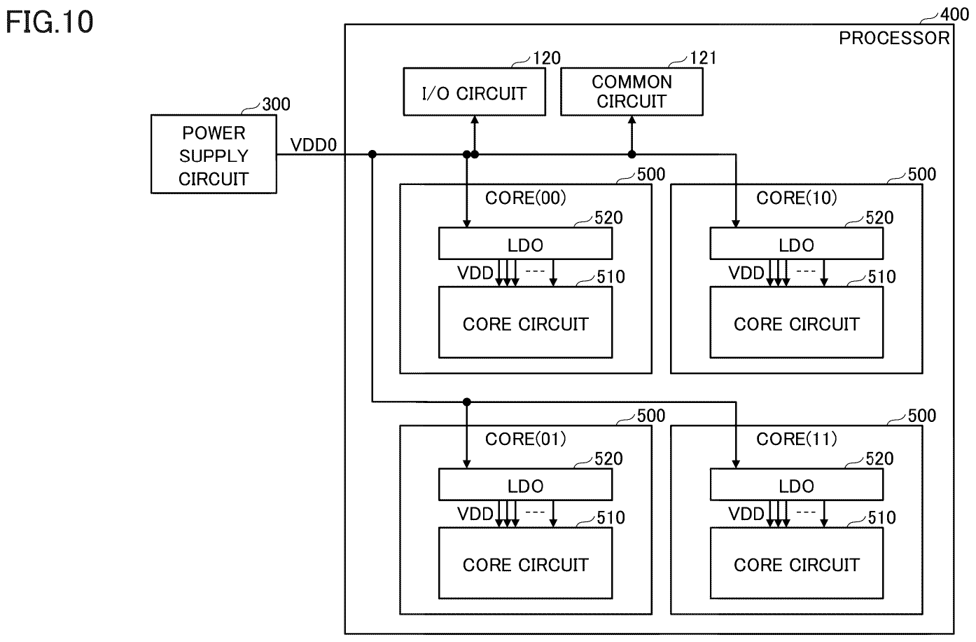

FIG. 10 illustrates an example of another processor. Elements similar to those in FIG. 2 are denoted by the same reference numerals and detailed descriptions are omitted. A processor 400 illustrated in FIG. 10 has a plurality of cores 500, an I/O circuit 120, and a common circuit 121. As in FIG. 2, the processor 400 has four cores 500 indicated by identification numbers (00), (10), (01), and (11), and operates by receiving a power supply voltage VDD0 generated by the power supply circuit 300.

Each core 500 has a core circuit 510 and an LDO 520. The LDO 520 generates a plurality of power supply voltages VDD that reduce the power supply voltage VDD0 and supply them to a plurality of circuit areas of the core circuit 510. Some circuits of the LDO 520 are arranged in the core circuit 510. The core circuit 510 may include various computing units such as a floating-point computing unit, and various circuits such as a cache, a scheduler, and a register file.

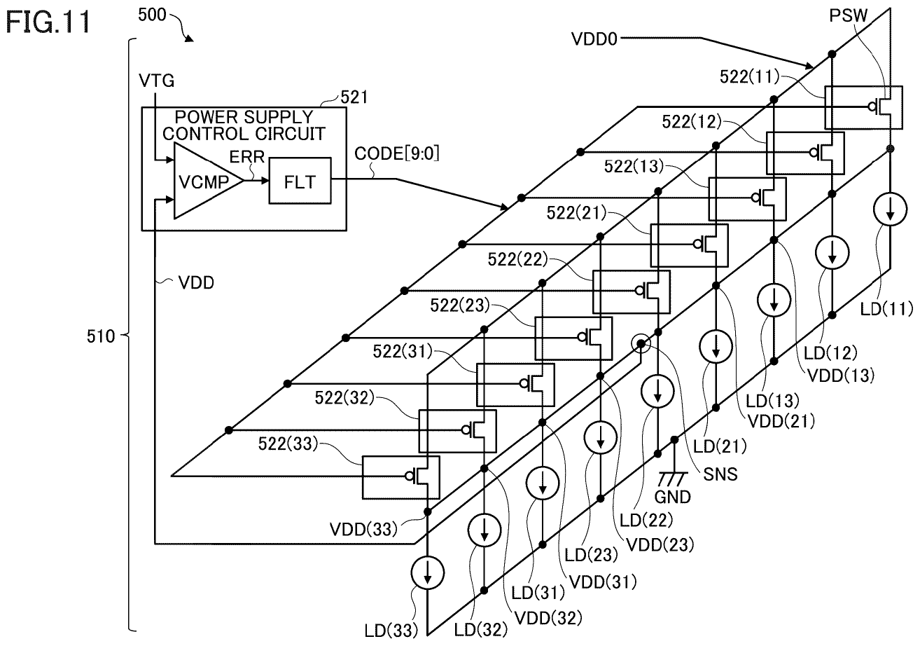

FIG. 11 illustrates an example of the power supply control circuit 521 and the power supply switch circuit 522 included in the LDO of FIG. 10. The same elements as those in FIG. 5 are denoted by the same reference numerals and detailed descriptions are omitted. The core circuit 510 is divided into 9 areas AR(xy) of 3 rows and 3 columns, and the power supply switch circuit 522 (xy) is arranged in each of the 9 areas AR(xy) of the core circuit 510, as in the case of the core circuit 210A of FIG. 3.

The power supply control circuit 521 has the same circuit configuration as the power supply control circuit 221A of FIG. 5. Each power supply switch circuit 522 (xy) has a circuit configuration excluding the multiplier MUL from the power supply switch circuit 222A (xy) of FIG. 5. Therefore, the power supply switch PSW of each power supply switch circuit 522 (xy) directly receives the code CODE [9:0] and operates. The detection position SNS for detecting the power supply voltage VDD is provided in the area AR(22) located in the center of the core circuit 510.

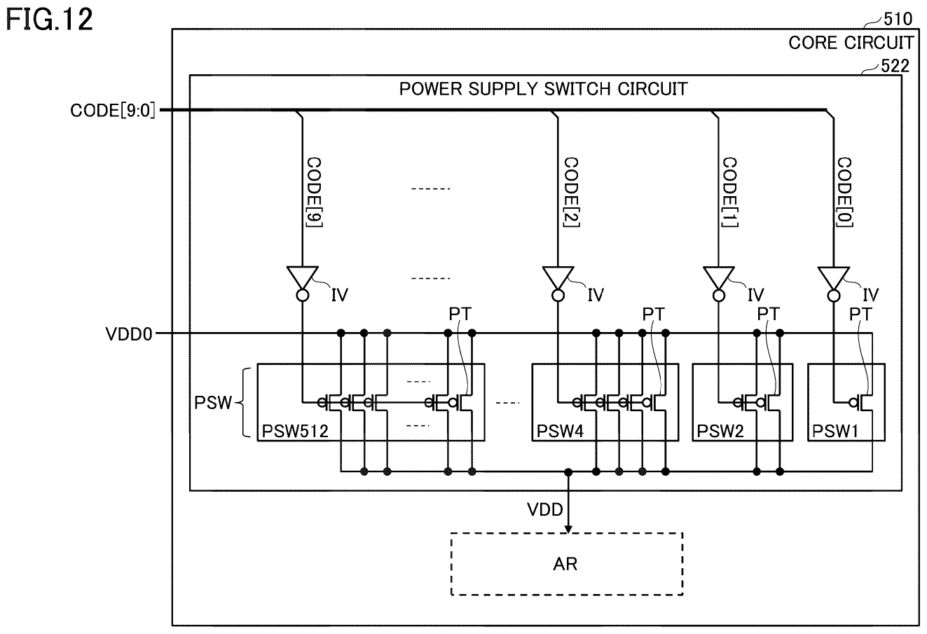

FIG. 12 illustrates an example of the power supply switch circuit 522 of FIG. 11. Elements similar to those illustrated in FIG. 6 are denoted by the same reference numerals and detailed descriptions are omitted. The power supply switch circuit 522 has the same circuit configuration as the power supply switch circuit 222A of FIG. 6 except that it does not have a multiplier MUL. Therefore, the power supply switch circuit 522 turns on the number of pMOS transistors PT indicated by the value of the code CODE [9:0], and supplies the power supply voltage VDD to the area AR with the current supply capacity corresponding to the value of the code CODE [9:0].

Even in the processor 400 illustrated in FIG. 10, as illustrated in FIG. 3, the power supply switch circuit 522 may be laid out at a position deviated from the center of each area AR. In this case, the power supply capacity of the power supply switch circuit 522 is insufficient, and a gradient of the power supply voltage VDD may occur in the core circuit 510.

Further, as illustrated in FIG. 7, if there is an area AR whose current consumption is larger than that of other areas AR, the power supply capacity of the area AR whose current consumption is large is insufficient, and a gradient of the power supply voltage VDD may occur in the core circuit 510. Further, as illustrated in FIG. 9, there is a case where the current consumption during the operation of the circuit mounted in one area AR is larger than the current consumption during the operation of the circuit mounted in another area AR. In this case, the power supply capacity is insufficient in the area AR in which the circuit with the large current consumption operates, and there is a possibility that a gradient of the power supply voltage VDD occurs in the core circuit 510.

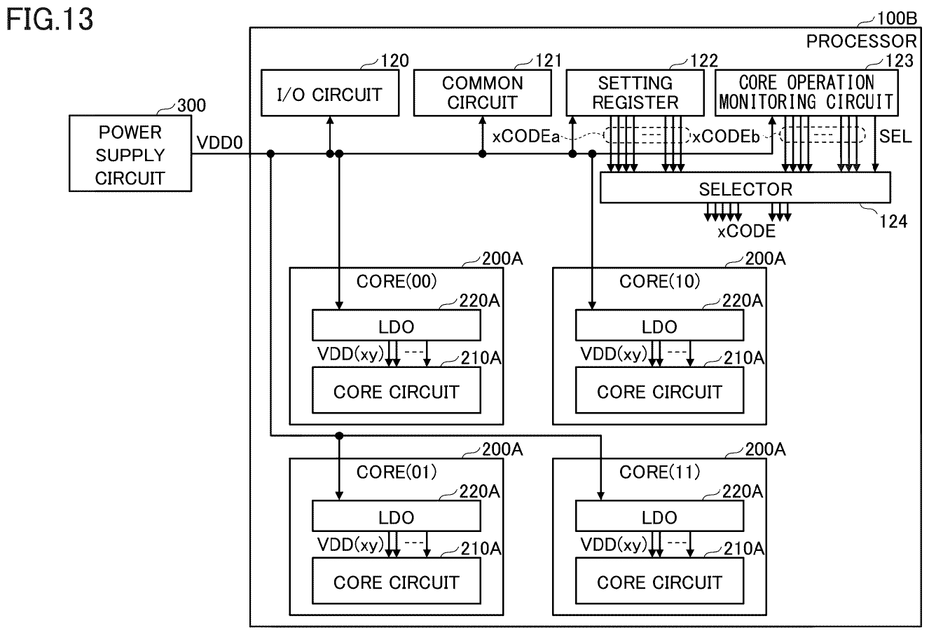

FIG. 13 illustrates an example of a processor according to another embodiment. Elements similar to those in FIGS. 2 and 8 are denoted by the same reference numerals, and a detailed description thereof is omitted. The processor 100B illustrated in FIG. 13 has the same circuit configuration as that of the processor 100A illustrated in FIG. 2 except that the core operation monitoring circuit 123 and the selector 124 are added to FIG. 2. FIG. 13 illustrates the setting register 122, the core operation monitoring circuit 123, and the selector 124 corresponding to the core circuit 210A of one core 200A. The setting register 122, the core operation monitoring circuit 123, and the selector 124 are provided for each core 200A. The operation of the processor 100B described below may be implemented by the operation control method of the processor 100B.

Like the setting register 122 in FIG. 2, the setting register 122 increases the value of the code xCODEa corresponding to the area AR including the shortage area where the power supply capacity is likely to be insufficient, because the position of the power supply switch circuit 222A is deviated from the center of the area AR. Alternatively, the setting register 122 increases the value of the code xCODEa corresponding to the area AR where the circuit with the large power consumption is installed, when the current consumption of the circuit installed in a certain area AR is larger than the current consumption of the circuit installed in another area AR.

The core operation monitoring circuit 123 increases the value of the code xCODEb corresponding to the area AR including the specific circuit until the operation of the specific circuit stops, when the specific circuit, whose current consumption during operation is larger than that of the other circuits, operates. The codes xCODEa and xCODEb are the same as the code xCODE output from the setting register 122 in FIG. 2 and the code xCODE output from the core operation monitoring circuit 123 in FIG. 8, respectively.

Further, the core operation monitoring circuit 123 outputs a selection signal SEL which causes the selector 124 to select the code xCODEb, when the specific circuit, whose current consumption during operation is larger than the current consumption during operation of the other circuits, operates. The core operation monitoring circuit 123 outputs a selection signal SEL which causes the selector 124 to select the code xCODEa when a specific circuit, whose current consumption during operation is larger than the current consumption during operation of the other circuits, does not operate.

The selector 124 selects one of the codes xCODEa and xCODEb according to the selection signal SEL from the core operation monitoring circuit 123, and outputs the selected code as the code xCODE to the core circuit 210A of each core 200A. That is, the selector 124 selects whether to adjust the power supply capacity based on the monitoring by the core operation monitoring circuit 123 or to increase the power supply capacity based on the increase amount of the power supply capacity held in the setting register 122.

Thus, a local power supply capacity shortage of the core circuit 210A caused by the circuit layout and a local power supply capacity shortage of the core circuit 210A caused by the circuit operation can be selectively eliminated. As a result, it is possible to prevent the occurrence of a gradient in the power supply voltage VDD in the core circuit 210A and to prevent a lowering of the operating voltage margin of the processor 100B.

As described above, the same effects as those of the embodiments illustrated in FIGS. 1 to 9 can be obtained in the embodiment illustrated in FIG. 13. Further, in the embodiment illustrated in FIG. 13, a local power supply capacity shortage of the core circuit 210A caused by the circuit layout and a local power supply capacity shortage of the core circuit 210A caused by the circuit operation can be eliminated. As a result, it is possible to prevent the occurrence of a gradient in the power supply voltage VDD in the core circuit 210A and to prevent the lowering of the operating voltage margin of the processor 100B.

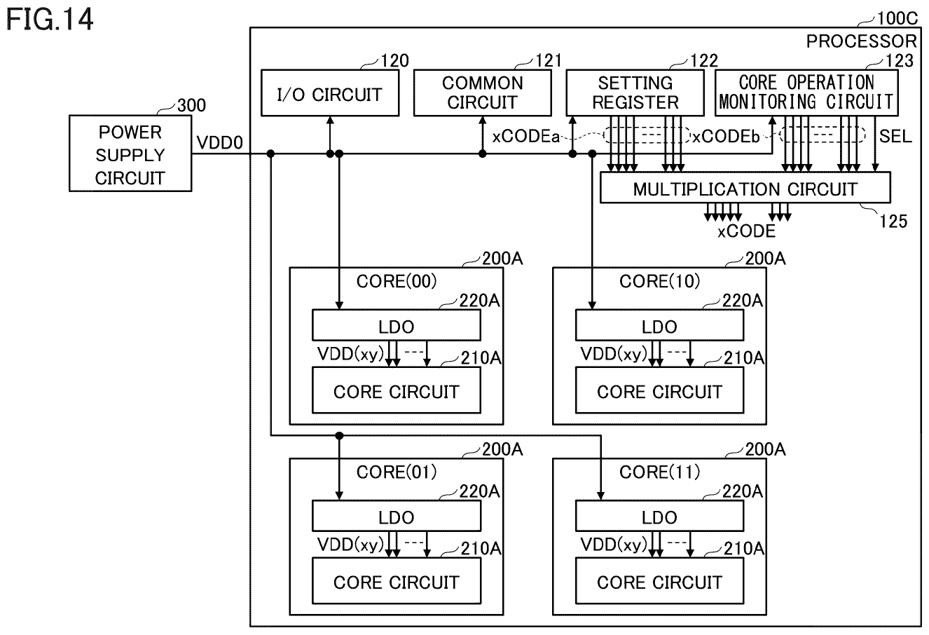

FIG. 14 illustrates an example of a processor according to another embodiment. The same elements as those in FIG. 13 are denoted by the same reference numerals, and a detailed description thereof is omitted. The processor 100C illustrated in FIG. 14 has the same circuit configuration as that of the processor 100B illustrated in FIG. 13 except that the multiplication circuit 125 is arranged instead of the selector 124 illustrated in FIG. 13. FIG. 14 illustrates the setting register 122, the core operation monitoring circuit 123, and the multiplication circuit 125 corresponding to the core circuit 210A of one core 200A. The setting register 122, the core operation monitoring circuit 123, and the multiplication circuit 125 are provided for each core 200A. The operation of the processor 100C described below may be implemented by the operation control method of the processor 100C.

The multiplication circuit 125 multiplies the area AR of the core circuit 210A by the corresponding codes xCODEa and xCODEb, and outputs the result of the multiplication to the power supply switch circuit 222A arranged in the corresponding area AR as the code xCODE. That is, the multiplication circuit 125 multiplies the code xCODEa, which indicates the increase amount of the power supply capacity held in the setting register 122, by the code xCODEb, which indicates the adjustment amount of the power supply capacity output from the core operation monitoring circuit 123.

For example, it is assumed that there is a circuit, whose current consumption during operation is larger than that of the circuit mounted in the other area AR, in the area AR(31) including the area indicated by the circle indicated by a dashed line in FIG. 3. In this case, in the setting register 122, the value of the code xCODEa corresponding to the areas AR(21), AR(31) and AR(32) including the area indicated by the circle indicated by a dashed line in FIG. 3, is set to be larger than the value of the code xCODEa of the other areas AR. Also, when the circuit with a large power consumption mounted in the area AR(31) operates, the core operation monitoring circuit 123 sets the value of the code xCODEb corresponding to the area AR(31) to be larger than the value of the code xCODEb of the other areas AR.

As a result, in the code xCODE output from the multiplication circuit 125, for example, the value (magnification) of the code xCODE corresponding to the area AR(31) becomes the largest, and the value (magnification) of the code xCODE corresponding to the areas AR(21) and AR(32) becomes the next largest. In order to maintain the value of the code CODE [9:0] output from the power supply control circuit 221A in FIG. 5, the value of the code xCODE corresponding to the other areas AR is set to a value indicating 1 times.

Based on the result of the multiplication by the multiplication circuit 125, the power supply capacity of the power supply switch circuit 222A arranged near the shortage area where the power supply capacity is insufficient, is adjusted. As a result, the local power supply capacity shortage of the core circuit 210A occurring in one or more of the areas AR due to both the circuit layout and the circuit operation can be eliminated.

As described above, the same effect as the embodiments illustrated in FIGS. 1 to 9 can be obtained in the embodiment illustrated in FIG. 14. Further, in the embodiment illustrated in FIG. 13, it is possible to eliminate the lack of local power supply capability of the core circuit 210A that occurs in one or more of the areas AR due to both circuit layout and circuit operation.

With the above detailed description, the features and advantages of the embodiments will become clear. It is intended that the scope of the claims extend to the features and advantages of the embodiments described above without departing from the spirit and scope of the claims. Moreover, any improvements and changes would be readily apparent to those with ordinary knowledge in the art. Therefore, it is not intended to limit the scope of inventive embodiments to those described above, but the embodiments may depend on suitable improvements and equivalents within the scope disclosed in the embodiments.

According to an aspect of the embodiments, the lowering of the operating voltage margin of the processor can be prevented by preventing a gradient from occurring in the power supply voltage in the internal circuit.

The present invention is not limited to the specific embodiments described herein, and variations and modifications may be made without departing from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustration of the superiority and inferiority of the invention. Although the embodiments of the present invention have been described in detail, it should be understood that the various changes, substitutions, and alterations could be made hereto without departing from the spirit and scope of the invention.

What is claimed is:

1. A processor comprising:
an internal circuit;
a plurality of power supply switch circuits arranged by being distributed in the internal circuit, each of the plurality of power supply switch circuits being configured to supply a power supply voltage to the internal circuit;
a first control circuit configured to control the plurality of power supply switch circuits based on a result of comparison between a power supply voltage and a target voltage at a detection position provided in the internal circuit, and cause the power supply voltage in the internal circuit to be closer to the target voltage; and
a second control circuit configured to increase a power supply capacity of the power supply switch circuit arranged near a shortage area, compared to a power supply capacity of the power supply switch circuit arranged at a position away from the shortage area, when there is the shortage area having a shortage in a power supply capacity in the internal circuit.

2. The processor according to claim 1, wherein
the first control circuit outputs a first control signal for changing the power supply capacity of the plurality of power supply switch circuits based on the result of the comparison,
the second control circuit outputs a second control signal for increasing the power supply capacity of the power supply switch circuit arranged near the shortage area, among a plurality of the second control signals respectively corresponding to the plurality of power supply switch circuits,
each of the plurality of power supply switch circuits includes a plurality of power supply switches arranged between an external power supply line and an internal power supply line to which the power supply voltage is supplied in the internal circuit, and
a power supply capacity of each of the plurality of power supply switch circuits is adjusted by turning on or off the plurality of power supply switches based on the first control signal common to the plurality of power supply switch circuits and the second control signal unique to each of the plurality of power supply switch circuits.

3. The processor according to claim 2, wherein
the first control circuit outputs the first control signal of n bits (n being an integer greater than or equal to 1) based on the result of the comparison, and
each of the plurality of power supply switch circuits includes:
an n number of the power supply switches, each provided to correspond to a corresponding bit of the bits of the first control signal, the n power supply switches having a current supply capacity with respect to the internal circuit that are sequentially different from each other by two times; and
an adjustment circuit configured to adjust a value indicated by the n bits of the first control signal, according to a value indicated by the second control signal, and output each bit of the adjusted value to the corresponding power supply switch.

4. The processor according to claim 3, wherein the adjustment circuit includes a multiplier configured to generate the adjusted value by multiplying the value indicated by the first control signal by the value indicated by the second control signal.

5. The processor according to claim 1, wherein
the shortage area occurs due to an arrangement density of the power supply switch circuits in the internal circuit being lower than other areas in the internal circuit, and
the second control circuit includes a holding unit configured to hold an increase amount in the power supply capacity of the power supply switch circuit arranged near the shortage area, and increases the power supply capacity of the power supply switch circuit arranged near the shortage area according to the increase amount held in the holding unit.

6. The processor according to claim 5, wherein
the holding unit holds the increase amount in the power supply capacity according to an amount of deviation, the deviation being from a position of the power supply switch circuit when the plurality of power supply switch circuits are arranged by being evenly distributed in the internal circuit, and
the increase amount held in the holding unit is set to a value which increases the current supply capacity as the amount of deviation increases.

7. The processor according to claim 1, wherein
the shortage area occurs when a circuit having a higher current consumption than other areas in the internal circuit, is arranged in the internal circuit, and
the second control circuit includes a holding unit configured to hold an increase amount in the power supply capacity of the power supply switch circuit arranged near the shortage area, and increases the power supply capacity of the power supply switch circuit arranged near the shortage area according to the increase amount held in the holding unit.

8. The processor according to claim 1, wherein
the second control circuit includes an operation monitoring circuit configured to monitor an operation of a first circuit included in a circuit area that becomes the shortage area due to a shortage in the power supply capacity during operation, among a plurality of circuit areas in the internal circuit, and
the operation monitoring circuit increases the power supply capacity of the power supply switch circuit arranged near the first circuit when the shortage area occurs due to the operation of the first circuit, and restores the power supply capacity of the power supply switch circuit arranged near the first circuit to an original value when the shortage area disappears due to a stop of operation of the first circuit.

9. The processor according to claim 8, wherein
the second control circuit further includes:
a holding unit configured to hold an increase amount in the power supply capacity of the power supply switch circuit arranged near the shortage area, the shortage area occurring when an arrangement density of the power supply switch circuits in the internal circuit is lower than that of other areas in the internal circuit, or when a circuit having a current consumption higher than that of other areas in the internal circuit is arranged in the internal circuit; and
a selector configured to select whether to adjust the power supply capacity based on the monitoring by the operation monitoring circuit or to increase the power supply capacity based on the increase amount held in the holding unit.

10. The processor according to claim 8, wherein
the second control circuit further includes:
a holding unit configured to hold an increase amount in the power supply capacity of the power supply switch circuit arranged near the shortage area, the shortage area occurring when an arrangement density of the power supply switch circuits in the internal circuit is lower than that of other areas in the internal circuit, or when a circuit having a current consumption higher than that of other areas in the internal circuit is arranged in the internal circuit; and
a multiplication circuit configured to multiply an adjustment amount of the power supply capacity adjusted by the operation monitoring circuit, by the increase amount held in the holding unit, and
the power supply capacity of the power supply switch circuit arranged near the shortage area is adjusted based on a result of multiplication performed by the multiplication circuit.

11. A method for controlling an operation of a processor, the processor including:
an internal circuit; and
a plurality of power supply switch circuits arranged by being distributed in the internal circuit, each of the plurality of power supply switch circuits being configured to supply a power supply voltage to the internal circuit, the method comprising:
controlling, by a first control circuit included in the processor, the plurality of power supply switch circuits based on a result of comparison between a power supply voltage and a target voltage at a detection position provided in the internal circuit, and causing the power supply voltage in the internal circuit to be closer to the target voltage; and
increasing, by a second control circuit included in the processor, a power supply capacity of the power supply switch circuit arranged near a shortage area, compared to a power supply capacity of the power supply switch circuit arranged at a position away from the shortage area, when there is the shortage area having a shortage in a power supply capacity in the internal circuit.
